(19) United States
(12) Patent Application Publication
(10) Pub. No.: US 2008/0071981 A1
(43) Pub. Date: Mar. 20, 2008

(54) METHOD OF PROVIDING DEFECT LIST FOR OPTICAL DISC

(75) Inventors: Ying-Che Hung, Taipei Hsien (TW); Ching-Wen Hsueh, Yilan County (TW); Shih-Hsin Chen, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/533,394

(22) Filed: Sep. 20, 2006

(51) Int. Cl. G06F 12/00

(52) U.S. Cl. 711/112

(57) ABSTRACT

A method of providing a defect list of a data storage media for a disc drive system. The defect list comprises a plurality of list entries. The method comprises dividing the list entries of the defect list into a plurality of groups, and providing at least one of the groups for the disc drive system.

### BACKGROUND OF THE INVENTION

1. Field of the Invention

The invention relates to the optical discs, and more specifically to methods and systems reducing the size of defect lists.

2. Description of the Related Art

Optical discs are widely used having advantages of large capacity and convenience. Optical discs include read-only discs such as CD-ROM and DVD-ROM, writeable discs such as CD-R and DVD-R, and rewritable discs such as CD-RW, DVD-RAM and DVD+RW.

Defects in Optical disc surfaces due to process imperfections and impurities can generate problems with write or reproduction operations. Thus, optical discs are tested to identify defective sectors after manufacture and before operations. Addresses of the identified defective sectors are listed in a defect list. When performing operations on optical discs, disc drives identify defective sectors using the defect list and avoid them accordingly.

Generally, the defect list comprises a plurality of list entries, identifying the physical location, i.e. physical sector number (PSN) of each defective sector and that of its corresponding replacement sectors. FIG. 1 shows the format of a list entries of a defect list for optical discs, such as blue-ray discs. Each list entry comprises a status 1 field, a defect cluster PSN field, a status 2 field, and a replacement cluster PSN field. The defect cluster PSN and replacement cluster PSN fields represent the PSN of the first defective sector of the cluster and that of a corresponding replacement sector respectively, wherein a spare area of optical discs is reserved for defect replacement, for example, PSNs 9000˜10000 of optical disc are reserved as the spare area thereof for defect replacement. The status 1 and status 2 fields represent the type of list entries. The value of the status 1 field refers to different type of list entries, including types RAD, NRD, SPR, PBA and Unusable. RAD list entry identifies a defective cluster with a replacement cluster assigned with values in the defect cluster PSN and replacement cluster PSN fields, identifying the first PSN of the defective cluster and that of the replacement cluster therefor. NRD list entry identifies a defective cluster without a replacement cluster assigned thereto. SPR list entry identifies a spare location usable for future replacement. PBA list entry identifies an area on the disc, that might be defective and has to be checked. Unusable list entry represents a spare location of the optical disc with a PSN as the replacement cluster PSN field of the list entry is unusable for future replacement.

Conventionally, during operations of an optical disc, the defect list thereof is read out first by a disc drive system and stored in a memory buffer accordingly. FIG. 2 shows a conventional disc drive system 200 accessing a data storage media 202 such as a DVD media, comprising a front-end unit 204, a memory interface 206, and a memory unit 208. The front-end unit 204 performs an operation on the data storage media 202 and retrieves a defect list comprising a plurality of list entries from data storage media 202. The memory interface 206 then stores the defect list in the memory units 208. The stored defect list can be used for defect monitoring, defect searching, and sector number conversion, such as logical sector number to physical sector number conversion. The size of the defect list, however, increases with the capacity of optical discs, occupying memory. It is especially more serious for embedded systems having smaller memory size. Thus, it is desirable to reduce the size of the defect list of optical discs, improving memory usage.

### BRIEF SUMMARY OF THE INVENTION

A detailed description is given in the following embodiments with reference to the accompanying drawings.

The invention is generally directed to a method of providing a defect list of a data storage media for a disc drive system, wherein the defect list comprises a plurality of list entries. An exemplary embodiment of a method of providing a defect list of a data storage media for a disc drive system comprises dividing the list entries of the defect list into a plurality of groups and providing at least one of the groups for the disc drive system.

A disc drive system for accessing a data storage media is further provided. The disc drive system comprises a front-end unit, a memory interface, a memory unit, and a defect information processing unit. The front-end unit performs an operation on the data storage media and retrieves a defect list from the data storage media, comprising a plurality of list entries. The memory unit stores the defect list from the front-end unit via the memory interface. The defect information processing unit obtains the defect list from the memory unit via the memory interface, divides the list entries of the defect list into a plurality of groups and stores at least one of the groups in the memory unit for the front-end unit via the memory interface.

Another method of providing a defect list of a data storage media for a disc drive system is provided, wherein the defect list comprises a plurality of list entries. The method comprises compressing the defect list and storing the compressed defect list.

Another disc drive system for accessing a data storage media is provided. The disc drive system comprises a front-end unit, a memory interface, a memory unit, and a compression unit. The front-end unit performs an operation on the data storage media and retrieves a defect list from the data storage media, comprising a plurality of list entries. The memory unit stores the defect list from the front-end unit via the memory interface. The compression unit obtains the defect list from the memory unit via the memory interface to compress the obtained defect list and stores the compressd defect list in the memory unit for the front-end unit via the memory interface.

Still, another method of providing a defect list of a data storage media for a disc drive system is provided, wherein the defect list comprises a plurality of list entries. The method comprises dividing the list entries of the defect list into a plurality of groups, compressing at least one of the groups, and storing at least one compressed group for the disc drive system.

Further, another disc drive system for accessing a data storage media is provided. The disc drive system comprises a front-end unit, a memory interface, a memory unit, and a control unit. The front-end unit performs an operation on the data storage media and retrieves a defect list from the data storage media, comprising a plurality of list entries. The memory unit stores the defect list from the front-end unit via the memory interface. The control unit comprises a defect information processing element, a compression element, and a determination element. The defect information processing element obtains the defect list from the memory unit via the memory interface and divides the list entries of the defect list into a plurality of groups. The compression element compresses the groups of the defect list from the defect information processing element. The determination element determines at least one of the compressed groups from the compression element to store in the memory unit for the front-end unit via the memory interface.

### BRIEF DESCRIPTION OF THE DRAWINGS

The invention can be more fully understood by reading the subsequent detailed description and examples with references made to the accompanying drawings, wherein:

FIG. 1 shows the format of list entries of the defect list of optical discs.

FIG. 2 is a block diagram of a conventional disc drive system.

FIG. 3 is a flowchart of a method of providing a defect list of a data storage media for a disc drive system according to an embodiment of the invention.

FIG. 4 is a schematic diagram of an exemplary defect list divided according to the defect cluster PSN of each list entry thereof.

FIG. 5 is a schematic diagram of an exemplary defect list divided according to the defective entry type of each list entry thereof.

FIG. 6 is a schematic diagram of an exemplary defect list divided according to the defect cluster PSN and defective entry type of each list entry thereof.

FIG. 7 is a block diagram of a disc drive system according to an embodiment of the invention.

FIG. 8 is a flowchart of a method of providing a defect list of a data storage media for a disc drive system according to another embodiment of the invention.

FIG. 9 is a flowchart of an exemplary compression method in FIG. 8.

FIG. 10 is a schematic diagram of sectors of an exemplary data storage media comprising a user data area for data record and a spare area for defect replacement.

FIGS. 11A and 11B show a list entry of the defect list of the data storage media of FIG. 10 before and after compression respectively.

FIG. 12 is a block diagram of a disc drive system according to another embodiment of the invention.

FIG. 13 is a flowchart of a method of providing a defect list of a data storage media for a disc drive system according to another embodiment of the invention.

FIG. 14 is a block diagram of a disc drive system according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

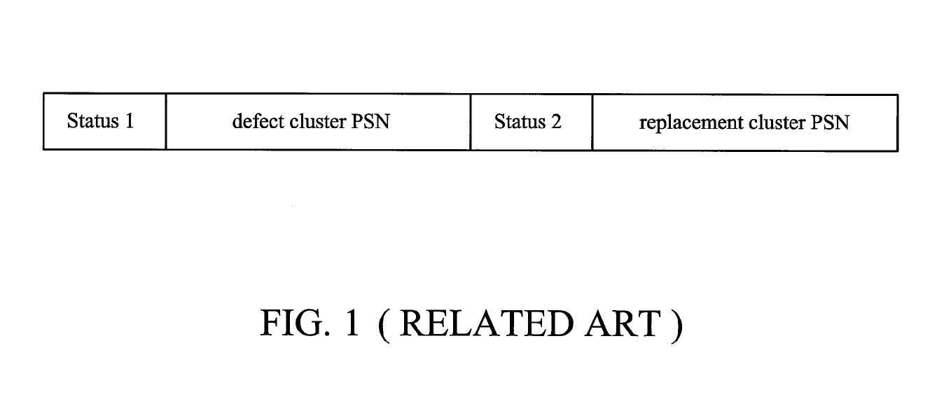

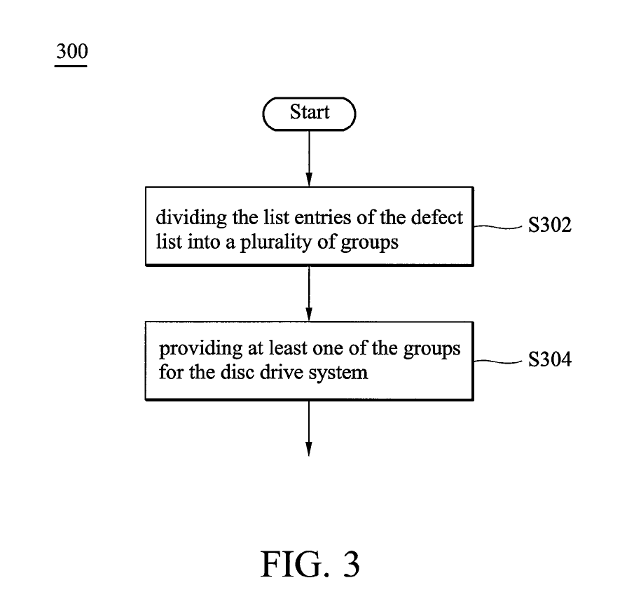

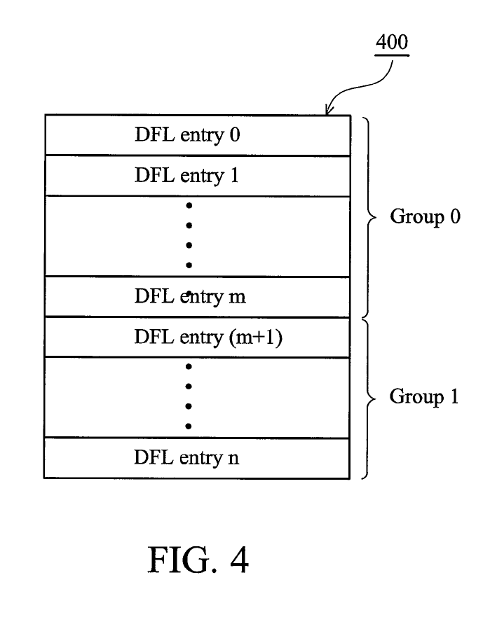

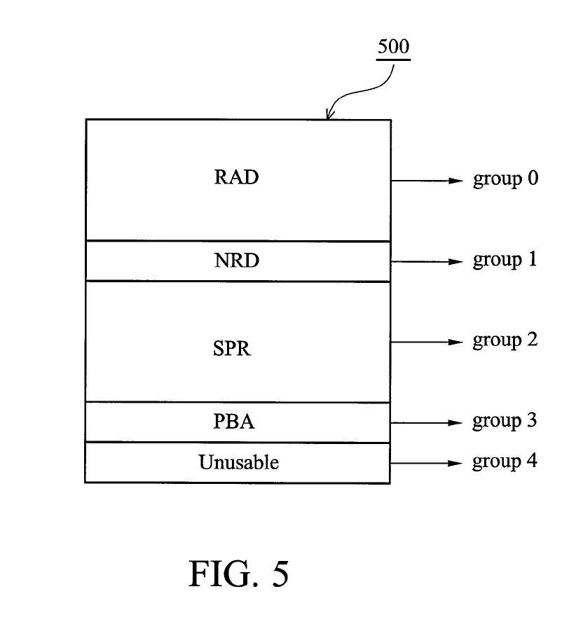

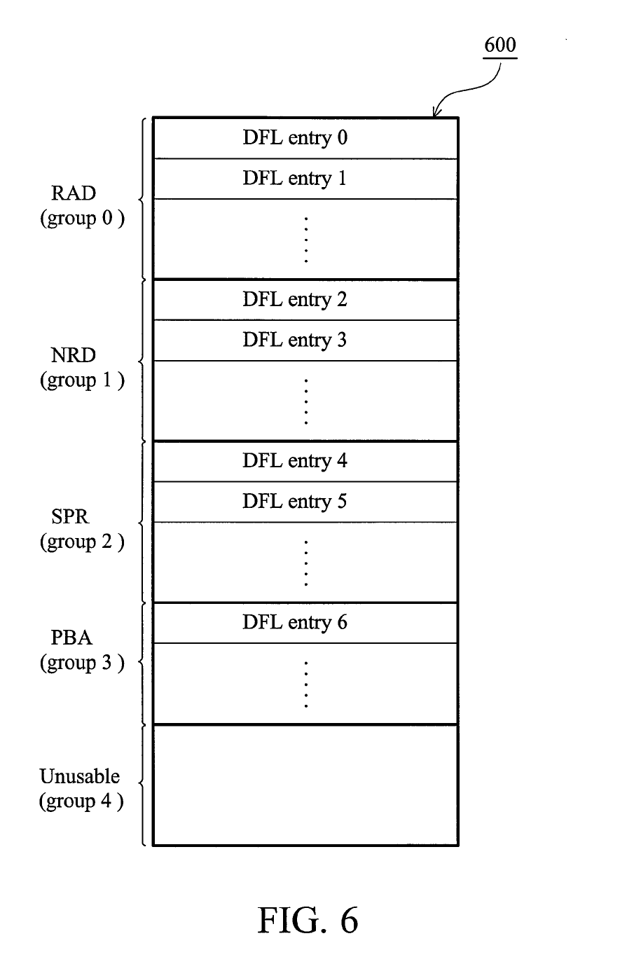

FIG. 3 is a flowchart of a method 300 of providing a defect list of a data storage media for a disc drive system according to an embodiment of the invention, wherein the defect list comprises a plurality of list entries. In step S302, the list entries of the defect list are divided into a plurality of groups. The number of groups into which the defect list is divided corresponds to design necessity and memory limitation. Step S304 follows step S302, wherein at least one of the groups of the list entries is provided for the disc drive system. The list entries of the defect list may be divided into groups in various ways. As shown in FIG. 1, each list entry of the defect list comprises a defect cluster physical sector number (PSN) and a defective entry type status 1. Thus, in an embodiment of the invention, the list entries of the defect list may be divided into groups according to the defect cluster PSN of each list entry. FIG. 4 shows a schematic diagram of a defect list 400 divided into two groups 0 and 1, according to the defect cluster PSN of each list entry thereof. The list entries of the defect list 400 are listed in order as DFL entry 0 to DFL entry n according to the defect cluster PSNs thereof, wherein DFL entries 0 to m belong to the group 0, and DFL entries (m+1) to n belong to the group 1. In this way, before step S304, providing at least one of the groups, the at least one of the groups of the list entries is determined according to a current location of the data storage media on which the disc drive system performs an operation, wherein the defect cluster physical PSNs of the list entries of the determined at least one group correspond to the current location of the data storage media on which the disc drive system performs the operation. For example, if the disc drive system is performing operations on physical sector 2000 to 4000 of the data storage media and the defect cluster PSNs of the group 0 are 0˜10000, it is enough for the disc drive system to have the information of only the group 0 of list entries of the defect list. Thus, by storing only a part of the defect list, system performance is retained and occupied memory size reduced. In another embodiment of the invention, the list entries of the defect list may be divided into groups according to a defective entry type of each list entry of the defect list 500 shown in FIG. 5. As shown, the list entries of the defect list 500 are listed in order according to the defective entry type thereof, wherein list entries having the same defective entry type are grouped together, and having defective entry types RAD, NRD, SPR PBA and unusable are groups 0, 1, 2, 3, and 4 respectively. Thus, before providing at least one of the groups of the defect list in step S304, the at least one of the groups of the list entries is determined according to an operation performed by the disc drive system on the data storage media. For example, when reading data from the data storage media, the disc drive system may require only the information of list entries with defective entry types are RAD, PBA and NRD. Hence, as shown in FIG. 5, only groups 0, 1 and 3 of list entries are stored in the memory. With only storing a part of the defect list in the memory, the memory occupied thereby is reduced accordingly. Alternatively, the list entries of the defect list may be divided into groups according to the defect cluster PSN and defective entry type of each list entry. FIG. 6 is a schematic diagram of a defect list 600 divided into five groups according to the defect cluster PSN and defective entry type of each list entry. As shown, the list entries of the defect list 600 are divided into groups 0˜4 according to the defective entry type thereof and the list entries in each group are listed in order according to the defect cluster PSN thereof. Thus, before providing at least one of the groups of the defect list in the step S304, the at least one of the groups of the list entries is determined according to the current location of the data storage media on which the disc drive system performs an operation and the operation performed. Because, as stated, the disc drive system does not need the full defect list, conversely, only a part thereof is required according to the physical sector of the data storage media on which it is performing an operation and the type of the operation. For example, if the disc drive system is reading data from sector numbers 1000 to 2000 of the data storage media, it is efficient to provide list entries of groups 0, 1 and 3 with defective cluster PSNs within 1000 to 2000.

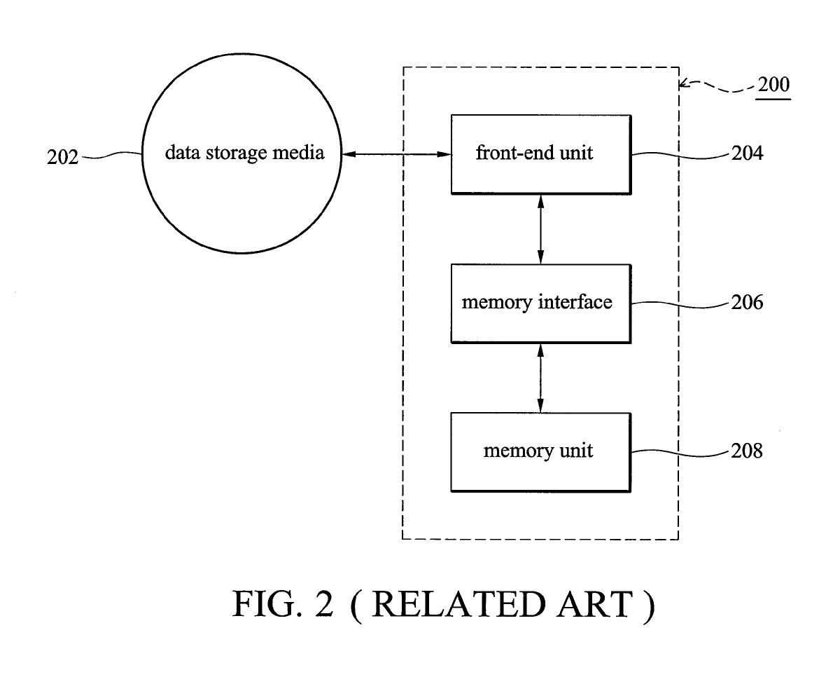

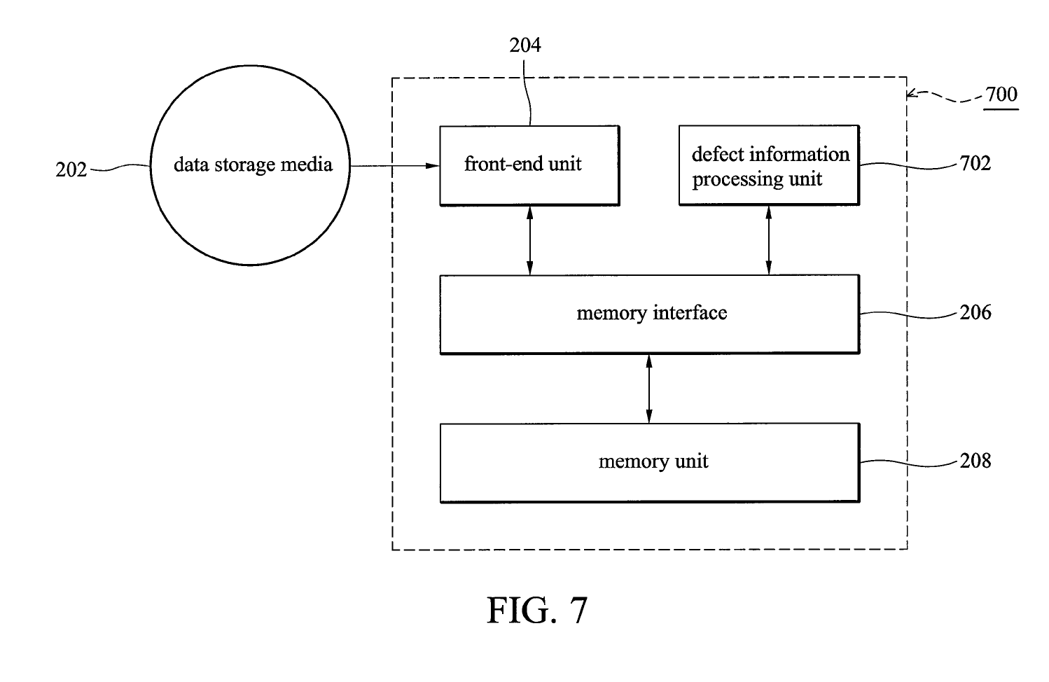

FIG. 7 illustrates a disc drive system 700 for accessing a data storage media 202 according to embodiments of the invention. It is understood that units shown in FIG. 7 are similar to units shown in FIG. 2, and are identified by the same reference numbers. The disc drive system 700 further comprises a defect information processing unit 702. The defect information processing unit 702 obtains the defect list from the memory unit 208 via the memory interface 206, divides the obtained list entries of the defect list into a plurality of groups and then stores at least one of the groups of the list entries in the memory unit 208 via the memory interface 206 for the front-end unit 204. Thus, the disc drive system 700 may utilize the stored at least one of the groups of the defect list to identify defective sectors of the data storage media 202. In an embodiment of the invention, the defect information processing unit 702 determines the at least one of the groups of the defect list for storing in the memory unit 208 according to a current location of the data storage media 202 on which the front-end unit 204 performs the operation. That is, with the information of the physical sector number of the data storage media 202 that the front-end unit 204 performs operations thereon, the defect information processing unit 702 may store some groups of the defect list for the front-end unit 204 to perform operations thereon. In this case, the defect information processing unit 702 divides the list entries of the defect list into the groups according to a defect cluster physical sector number (PSN) of each list entry as shown in FIG. 4. The defect cluster physical PSNs of the list entries of the group determined by the defect information processing unit 702 to store in the memory unit 208 correspond to the current location of the data storage media 202 on which the front-end unit 204 performs the operation.

In another embodiment of the invention, the defect information processing unit 702 determines the at least one of the groups of the defect list for storing in the memory unit 208 according to the operation performed by the front-end unit 204 on the data storage media 202. That is, with the information of operation type performed by the front-end unit 204, the defect information processing unit 702 may store only a part of the defect list in the memory unit 208 for the front-end unit 204. For example, as stated, if the front-end unit 204 is reading data from the data storage media 202, it may require only the information of list entries of the defect list with defective entry types RAD, PBA and NRD. Thus, list entries with other defective entry types, that are different groups, are not required. In this case, as shown in FIG. 5, the defect information processing unit 702 divides the list entries of the defect list into the groups according to a defective entry type of each list entry. Similarly, as shown in FIG. 6, the defect information processing unit 702 divides the list entries of the defect list into the groups according to a defect cluster PSN and a defective entry type of each list entry. In this way, the defect information processing unit 702 determines the at least one of the groups of the defect list for storing in the memory unit 208 according to a current location of the data storage media 202 on which the front-end unit 204 performs the operation and the operation type. Detail operations have been discussed previously and are thus not further described.

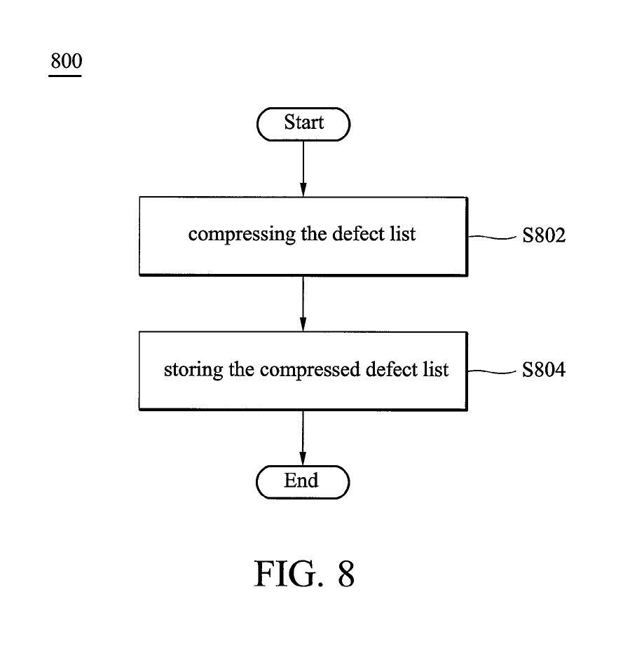

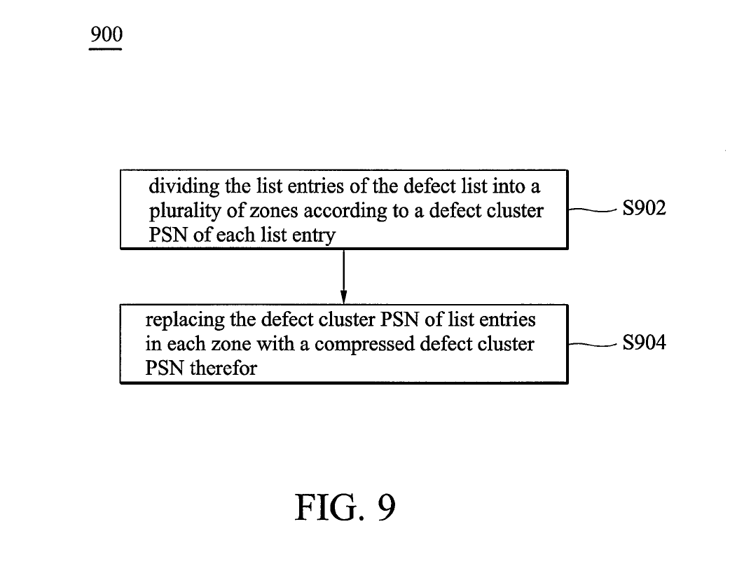

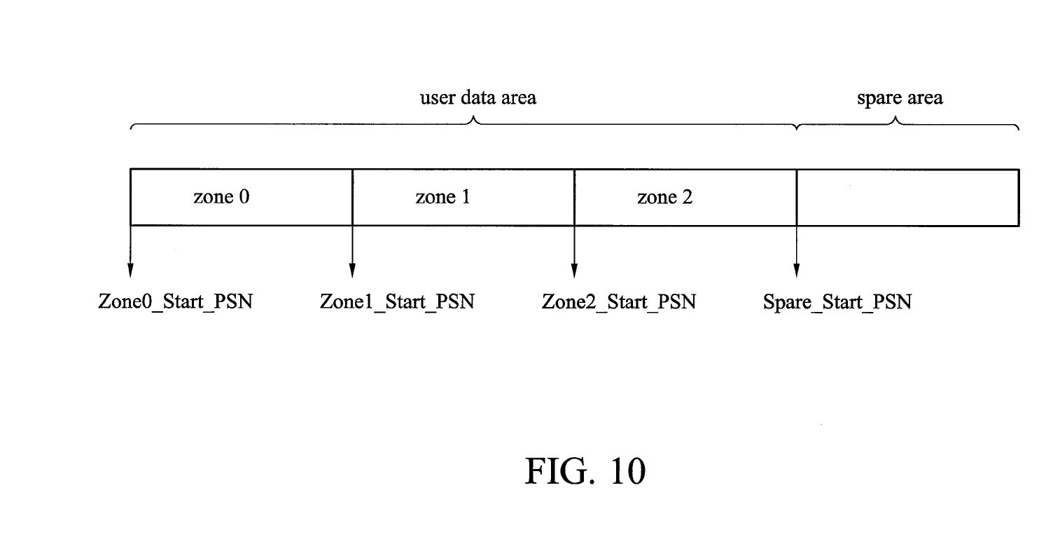

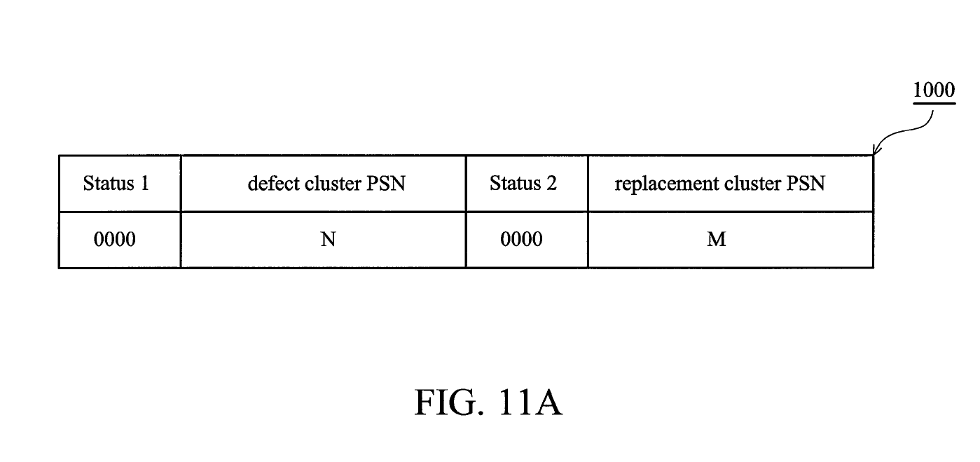

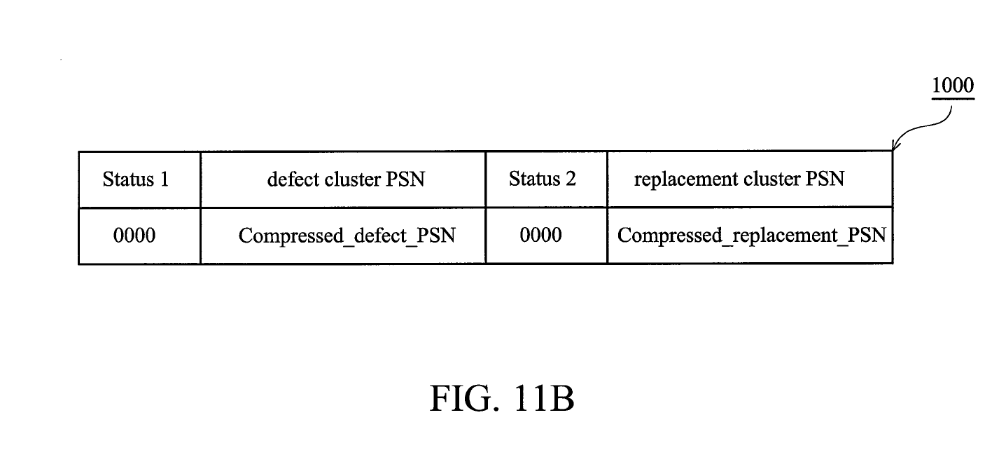

FIG. 8 is a flowchart of a method 800 of providing a defect list of a data storage media for a disc drive system according to an embodiment of the invention, wherein the defect list comprises a plurality of list entries. In step S802, the defect list is compressed. Step 804 follows step 802, wherein the compressed defect list is stored. FIG. 9 shows an exemplary compression method 900 for the defect list. In step S902, the list entries of the defect list are divided into a plurality of zones according to a defect cluster physical sector number (PSN) of each list entry. Followed by Step S904, the defect cluster physical sector number (PSN) of list entries in each zone is replaced with a compressed defect cluster PSN therefor. FIG. 10 shows sectors of a data storage media comprising a user data area for data record and a spare area for defect replacement. The sectors of the user data area of the data storage media are divided into three zones according to the physical sector numbers thereof. The list entries of the defect list are also distributed to zone 0 to zone 2 respectively in accordance with the defect cluster PSN of each list entry accordingly. For example, as shown, the user data area of the data storage media is divided into zones 0˜2, wherein the PSN of the first sector of zones 0˜2 are Zone0_Start_PSN, Zone1_Start_PSN, and Zone2_Start_PSN. The defect cluster physical sector number (PSN) of list entries in each zone is then replaced with a compressed defect cluster PSN therefor determined according to a physical sector number of a first sector in a corresponding zone, and a difference between the defect cluster PSN of each list entry and the PSN of the first sector of the corresponding zone. For example, FIG. 11A shows a list entry 1000 of the defect list of the data storage media in FIG. 10, wherein the defect cluster PSN field of the list entry 1000 is N. FIG. 11B shows the list entry 1000 after step S802, the original the defect cluster PSN of the list entry 1000 is replaced with the compressed defect cluster PSN, Compressed_defect_PSN, wherein Compressed_defect_PSN equals to (N-Zone_{i—}Start_PSN) and Zone_{i—}Start_PSN represents the PSN of the first sector of the zone i that the list entry 1000 is in. For example, if N is 2000 and the PSN of the zone 0 is from 1000 to 7500, wherein the fist sector of the zone 0, Zone0_Start_PSN, is 0, the Compressed_defect_PSN for list entry 1000 is (2000−1000)=1000.

Moreover, similarly, the replacement cluster PSN of the list entries of the defect list may also be compressed by being replaced with a compressed replacement cluster PSN determined according to a PSN of a first sector of a spare area of the data storage media and a difference between the replacement cluster PSN of each list entry and the PSN of the first sector of the spare area. FIG. 10 shows the spare area of the data storage media for defect replacement usually predetermined before operations. As shown, the spare area is not divided but left as one zone, wherein the PSN of the first sector of the spare area is represented by Spare_Start_PSN. The replacement cluster PSN field of the list entry 1000 of FIG. 11A is M and as shown in FIG. 11B, it is replaced with a compressed replacement cluster PSN, Compressed_replacement_PSN, wherein Compressed_replacement_PSN equals to (M-Spare_Start_PSN). For example, if the PSN of the spare area is from 9000 to 10000 and M is 9050, the compressed replacement cluster PSN for the list entry 1000 is (9050−9000)=50. Obviously, the size of the defect cluster PSN and replacement cluster PSN of list entries of the defect list is reduced after compression performed in step S802. Alternatively, either the compressed defect cluster PSN or replacement cluster PSN for list entries of the defect list may be determined according to a look-up table. This is known in the art, and thus not further described.

After step 804, the method 800 further comprises decompressing the compressed defect list and providing the decompressed defect list for the disc drive system to monitor the defects of the data storage media. It may not be necessary to decompress the entire compressed defect list but only a part of it according to the defect information that the disc drive system requires. Further, other methods of compression are compatible with the principles of the invention. The compression method of the defect list must be lossless compression. Further, the compression method is preferably not required to decompress the whole compressed defect list but the content of any list entry thereof can be obtained.

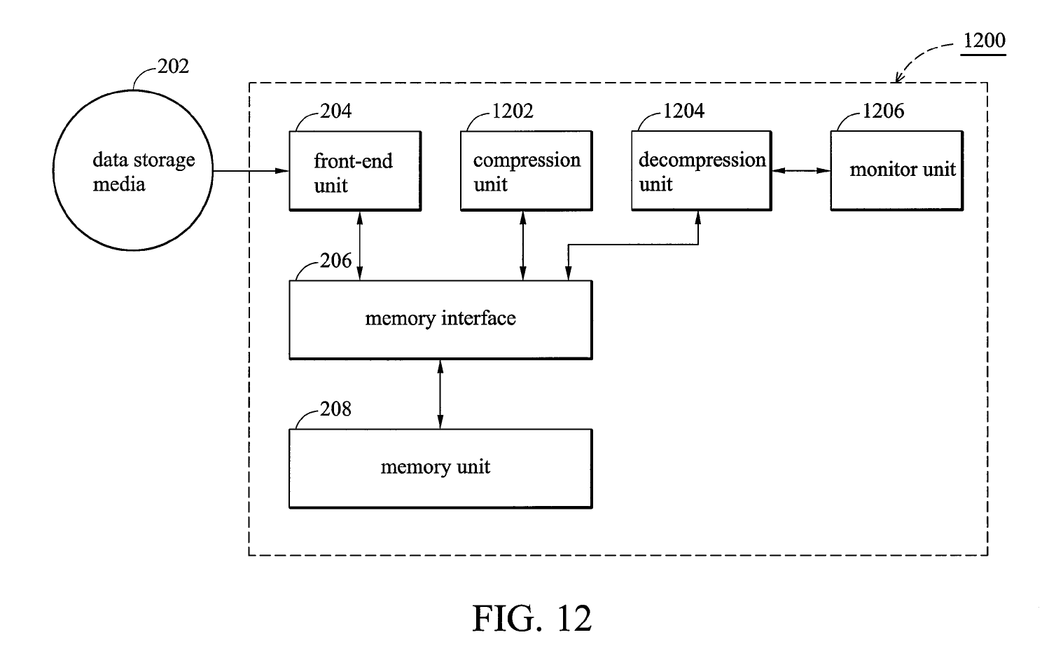

FIG. 12 illustrates a disc drive system 1200 for accessing a data storage media 202 according to embodiments of the invention. It is understood that units shown in FIG. 12 are similar to units shown in FIG. 2, and are identified by the same reference numbers. The disc drive system 1200 further comprises a compression unit 1202, a decompression unit 1204 and a monitor unit 1206. The compression unit 1202 obtains a defect list from the memory unit 208 via the memory interface 206 to compress the obtained defect list and stores the compressed defect list in the memory unit 208 for the front-end unit 204 via the memory interface 206. In an embodiment of the invention, when compressing the defect list, the compression unit 1202 divides the sectors of the user data area of the data storage media into a plurality of zones according to the physical sector numbers thereof as shown in FIG. 10, wherein the list entries of the defect list are divided into the zones accordingly. The compression unit 1202 then replaces the defect cluster physical sector number (PSN) of list entries in each zone with a compressed defect cluster PSN therefor. As shown in FIG. 11, the compressed defect cluster PSN for each list entry is determined according to a physical sector number of a first sector in a corresponding zone, and a difference between the defect cluster PSN of each list entry and the PSN of the first sector of the corresponding zone. Alternatively, the compression unit 1202 may further compresses the defect list by replacing a replacement cluster PSN of each list entry with a compressed replacement cluster PSN therefor determined according to a PSN of a first sector of a spare area of the data storage media and a difference between the replacement cluster PSN of each list entry and the PSN of the first sector of the spare area as shown in FIG. 11. Moreover, either the compressed defect cluster PSN or replacement cluster PSN for list entries of the defect list may be determined according to a look-up table.

After the compressed defect list is stored in the memory unit 208, the decompression unit 1204 obtains the compressed defect list from the memory unit 208 via the memory interface 206 to decompress the obtained defect list and stores the decompressed defect list in the memory unit 208. The monitor unit 1206 then receives the decompressed defect list from the decompression unit 1204 for monitoring the defects of the data storage media. It is noted that the decompression unit 1204 is not required to decompress the whole compressed defect list but only a part thereof to retrieve information of certain list entries that the disc drive system 1200 needs when performing operations.

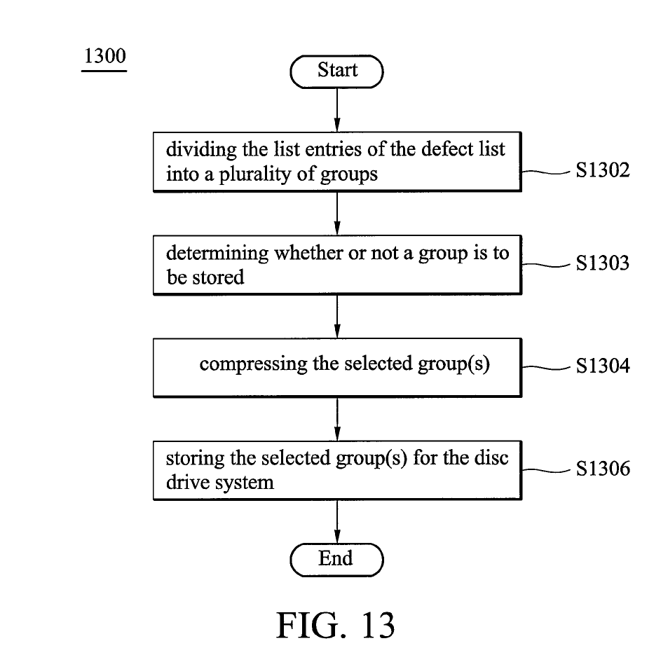

FIG. 13 is a flowchart of a method 1300 of providing a defect list of a data storage media for a disc drive system according to an embodiment of the invention, wherein the defect list comprises a plurality of list entries. In step S1302, the list entries of the defect list is divided into a plurality of groups. Whether or not a group needs to be stored is then determined in step S1303. The selected group(s) determined to be stored is compressed in step S1304 and stored for the disc drive system in step S1306. Similarly, the determination of the selected group(s) for storing and dividing of the defect list may be performed in accordance with a current location of the data storage media on which the disc drive system performs an operation and a defect cluster physical sector number PSN of each list entry respectively as shown in FIG. 4. As shown in FIG. 5, they may also be performed according to an operation performed by the disc drive system and defective entry type of each list entry respectively. Otherwise, as shown in FIG. 6, they can be performed as a combination as shown in FIG. 6.

Moreover, in Step S1304, as shown in FIGS. 10 and 11, the defect list in the selected group(s) may be compressed by dividing the list entries of the defect list into a plurality of zones according to a defect cluster PSN of each list entry and replacing the defect cluster PSN of list entries in each zone with a compressed defect cluster PSN therefor. Dividing the list entries into a plurality of zones and the determination of the compressed defect cluster PSN are similar to those in FIGS. 10 and 11 and are thus not described in further detailed. Similarly, the defect list in the selected group(s) may be further compressed by replacing the replacement cluster PSN of each list entry with a compressed replacement cluster PSN determined according to a PSN of a first sector of a spare area of the data storage media and a difference between the replacement cluster PSN of each list entry and the PSN of the first sector of the spare area. Further, a look-up table may be employed in determination of compressed defect cluster PSN and replacement cluster PSN.

After step S1306, the method 1300 further comprises decompressing at least one of the compressed groups stored and then providing at least one decompressed group of the defect list for the disc drive system to monitor the defects of the data storage media, wherein maybe only a part of the at least one compressed group is decompressed.

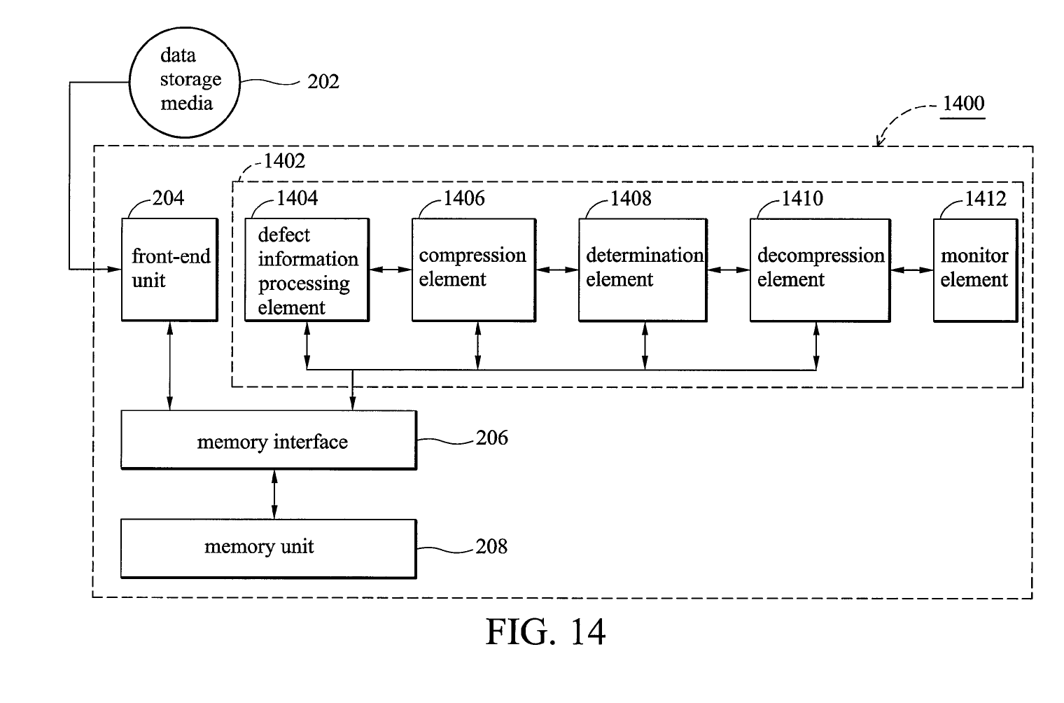

FIG. 14 illustrates a disc drive system 1400 for accessing a data storage media 202 according to embodiments of the invention. The units shown in FIG. 14 are similar to units shown in FIG. 2, and are identified by the same reference numbers. The disc drive system 1400 further comprises a control unit 1402 comprising a defect information processing element 1404, a compression element 1406, a determination element 1408, a decompression element 1410 and a monitor element 1412. The defect information processing element 1404 obtains the defect list from the memory unit 208 via the memory interface 206 and divides the list entries of the defect list into a plurality of groups. The compression element 1406 compresses the groups of the defect list from the defect information processing element 1404. The determination element 1408 determines at least one of the compressed groups from the compression element 1406 to store in the memory unit 208 for the front-end unit 204 via the memory interface 206. The decompression element 1410 obtains the compressed defect list from the memory unit 208 via the memory interface 206 to decompress the obtained defect list. The monitor element 1412 receives the decompressed defect list from the decompression element 1402 and monitors the defects of the data storage media therewith.

The defect information processing element 1404 may divides the list entries of the defect list into a plurality of groups and the determination element 1308 determines the at least one of the compressed groups for storing according those previously discussed with FIGS. 3˜6. Similarly, the compression element 1406 may compress the defect list according to principles stated with FIGS. 8˜11. Hence detailed operation of the disc drive system 1400 is not further described. Thus, according to embodiments of the invention, the size of the defect list of a data storage media is reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of providing a defect list of a data storage media for a disc drive system, wherein the defect list comprises a plurality of list entries, the method comprising:
dividing the list entries of the defect list into a plurality of groups; and
providing at least one of the groups for the disc drive system.

2. The method as claimed in claim 1, further comprising before providing, determining the at least one of the groups according to a current location of the data storage media on which the disc drive system performs an operation.

3. The method as claimed in claim 2, wherein dividing the list entries of the defect list comprises dividing the list entries of the defect list into the groups according to a defect cluster physical sector number (PSN) of each list entry.

4. The method as claimed in claim 3, wherein the defect cluster physical PSNs of the list entries of the determined group correspond to the current location of the data storage media on which the disc drive system performs the operation.

5. The method as claimed in claim 1, further comprising, before providing, determining the at least one of the groups according to an operation performed by the disc drive system on the data storage media.

6. The method as claimed in claim 5, dividing the list entries of the defect list comprises dividing the list entries of the defect list into the groups according to a defective entry type of each list entry.

7. The method as claimed in claim 1, further comprising, before providing, determining the at least one of the groups according to a current location of the data storage media on which the disc drive system performs an operation and the operation performed.

8. The method as claimed in claim 7, wherein dividing the list entries of the defect list comprises dividing the list entries of the defect list into the groups according to a defect cluster physical sector number (PSN) and a defective entry type of each list entry.

9. The method as claimed in claim 8, wherein the defect cluster physical PSNs of the list entries of the determined group correspond to the current location of the data storage media on which the disc drive system performs the operation.

10. A disc drive system for accessing a data storage media, comprising:
a front-end unit performing an operation on the data storage media and retrieving a defect list from the data storage media, comprising a plurality of list entries;
a memory interface;
a memory unit storing the defect list from the front-end unit via the memory interface; and
a defect information processing unit obtaining the defect list from the memory unit via the memory interface, dividing the list entries of the defect list into a plurality of groups and storing at least one of the groups in the memory unit for the front-end unit via the memory interface.

11. The disc drive system as claimed in claim 10, wherein the defect information processing unit determines the at least one of the groups of the defect list for storing in the memory unit according to a current location of the data storage media on which the front-end unit performs the operation.

12. The disc drive system as claimed in claim 11, wherein the defect information processing unit divides the list entries of the defect list into the groups according to a defect cluster physical sector number (PSN) of each list entry.

13. The disc drive system as claimed in claim 12, wherein the defect cluster physical PSNs of the list entries of the group determined by the defect information processing unit for storing in the memory unit correspond to the current location of the data storage media on which the front-end unit performs the operation.

14. The disc drive system as claimed in claim 10, wherein the defect information processing unit determines the at least one of the groups of the defect list for storing in the memory unit according to the operation performed by the front-end unit on the data storage media.

15. The disc drive system as claimed in claim 14, wherein the defect information processing unit divides the list entries of the defect list into the groups according to a defective entry type of each list entry.

16. The disc drive system as claimed in claim 10, wherein the defect information processing unit determines the at least one of the groups of the defect list for storing in the memory unit according to the current location of the data storage media on which the front-end unit performs the operation and the operation performed.

17. The disc drive system as claimed in claim 16, wherein the defect information processing unit divides the list entries of the defect list into the groups according to a defect cluster physical sector number (PSN) and a defective entry type of each list entry.

18. The disc drive system as claimed in claim 17, wherein the defect cluster physical PSNs of the list entries of the group determined by the defect information processing unit to store in the memory unit correspond to the current location of the data storage media on which the front-end unit performs the operation.

19. A method of providing a defect list of a data storage media for a disc drive system, wherein the defect list comprises a plurality of list entries, the method comprising:
compressing the defect list; and
storing the compressed defect list.

20. The method as claimed in claim 19, wherein compression comprises:
dividing the list entries of the defect list into a plurality of zones according to a defect cluster physical sector number (PSN) of each list entry; and
replacing the defect cluster physical sector number (PSN) of list entries in each zone with a compressed defect cluster PSN therefor.

21. The method as claimed in claim 20, wherein dividing the list entries of the defect list into a plurality of zones comprises dividing the sectors of the data storage media into the zones according to the physical sector numbers thereof and distributing the list entries of the defect list to each zone accordingly.

22. The method as claimed in claim 21, wherein the compressed defect cluster PSN for each list entry in each zone is determined according to a physical sector number of a first sector in a corresponding zone, and a difference between the defect cluster PSN of each list entry and the PSN of the first sector of the corresponding zone.

23. The method as claimed in claim 20, wherein the compressed defect cluster PSN for each list entry in each zone is determined according to a look-up table.

24. The method as claimed in claim 20, wherein compression further comprises replacing a replacement cluster PSN of each list entry with a compressed replacement cluster PSN therefor.

25. The method as claimed in claim 24, wherein the compressed replacement cluster PSN for each list entry is determined according to a PSN of a first sector of a spare area of the data storage media and a difference between the replacement cluster PSN of each list entry and the PSN of the first sector of the spare area.

26. The method as claimed in claim 24, wherein the compressed replacement cluster PSN for each list entry is determined according to a look-up table.

27. The method as claimed in claim 19, further comprising:
decompressing the compressed defect list; and
providing the decompressed defect list for the disc drive system to monitor the defects of the data storage media.

28. The method as claimed in claim 19, wherein decompressing comprises decompressing a part of the compressed defect list and providing the decompressed part of the defect list for the disc drive system.

29. A disc drive system for accessing a data storage media, comprising:
a front-end unit performing an operation on the data storage media and retrieving a defect list from the data storage media, comprising a plurality of list entries;
a memory interface;
a memory unit storing the defect list from the front-end unit via the memory interface; and
a compression unit obtaining the defect list from the memory unit via the memory interface to compress the obtained defect list and storing the compressed defect list in the memory unit for the front-end unit via the memory interface.

30. The disc drive system as claimed in claim 29, wherein the compression unit compresses the defect list by dividing the list entries of the defect list into a plurality of zones according to a defect cluster physical sector number (PSN) of each list entry and replacing the defect cluster physical sector number (PSN) of list entries in each zone with a compressed defect cluster PSN therefor.

31. The disc drive system as claimed in claim 30, wherein the compression unit divides the list entries of the defect list by dividing the sectors of the data storage media into the zones according to the physical sector numbers thereof and distributing the list entries of the defect list to each zone accordingly.

32. The disc drive system as claimed in claim 31, wherein the compression unit determines the compressed defect cluster PSN for each list entry in each zone according to a physical sector number of a first sector in a corresponding zone, and a difference between the defect cluster PSN of each list entry and the PSN of the first sector of the corresponding zone.

33. The disc drive system as claimed in claim 30, wherein the compression unit determines the compressed defect cluster PSN for each list entry in each zone according to a look-up table.

34. The disc drive system as claimed in claim 30, wherein the compression unit further compresses the defect list by replacing a replacement cluster PSN of each list entry with a compressed replacement cluster PSN therefor.

35. The disc drive system as claimed in claim 34, wherein the compression unit determines the compressed replacement cluster PSN for each list entry according to a PSN of a first sector of a spare area of the data storage media and a difference between the replacement cluster PSN of each list entry and the PSN of the first sector of the spare area.

36. The disc drive system as claimed in claim 34, wherein the compression unit determines the compressed replacement cluster PSN for each list entry according to a look-up table.

37. The disc drive system as claimed in claim 29, further comprising a decompression unit obtaining the compressed defect list from the memory unit via the memory interface to decompress the obtained defect list and storing the decompressed defect list in the memory unit for the front-end unit via the memory interface.

38. The disc drive system as claimed in claim 29, wherein the decompression unit decompresses a part of the obtained defect list and storing the decompressed part of the defect list in the memory unit accordingly.

39. The disc drive system as claimed in claim 37, further comprising a monitor unit receiving the decompressed defect list from the decompression unit and monitoring the defects of the data storage media therewith.

40. A method of providing a defect list of a data storage media for a disc drive system, wherein the defect list comprises a plurality of list entries, the method comprising:
dividing the list entries of the defect list into a plurality of groups;
compressing at least one of the groups; and
storing at least one compressed group for the disc drive system.

41. The method as claimed in claim 40, further comprising before storing, determining the at least one of the groups according to a current location of the data storage media on which the disc drive system performs an operation.

42. The method as claimed in claim 41, wherein dividing the list entries of the defect list comprises dividing the list entries of the defect list into the groups according to a defect cluster physical sector number (PSN) of each list entry.

43. The method as claimed in claim 40, further comprising, before storing, determining the at least one of the groups according to an operation performed by the disc drive system on the data storage media.

44. The method as claimed in claim 43, wherein dividing the list entries of the defect list comprises dividing the list entries of the defect list into the groups according to a defective entry type of each list entry.

45. The method as claimed in claim 40, further comprising, before storing, determining the at least one of the groups according to a current location of the data storage media on which the disc drive system performs an operation and the operation performed.

46. The method as claimed in claim 45, wherein dividing the list entries of the defect list comprises dividing the list entries of the defect list into the groups according to a defect cluster physical sector number (PSN) and a defective entry type of each list entry.

47. The method as claimed in claim 40, wherein the compression comprises:
dividing the list entries of the defect list into a plurality of zones according to a defect cluster physical sector number (PSN) of each list entry; and
replacing the defect cluster physical sector number (PSN) of list entries in each zone with a compressed defect cluster PSN therefor.

48. The method as claimed in claim 47, wherein dividing the list entries of the defect list into a plurality of zones comprises dividing the sectors of the data storage media into the zones according to the physical sector numbers thereof and distributing the list entries of the defect list to each zone accordingly.

49. The method as claimed in claim 48, wherein the compressed defect cluster PSN for each list entry in each zone is determined according to a physical sector number of a first sector in a corresponding zone, and a difference between the defect cluster PSN of each list entry and the PSN of the first sector of the corresponding zone.

50. The method as claimed in claim 47, wherein the compressed defect cluster PSN for each list entry of each zone is determined according to a look-up table.

51. The method as claimed in claim 47, wherein compression further comprises replacing a replacement cluster PSN of each list entry with a compressed replacement cluster PSN therefor.

52. The method as claimed in claim 51, wherein the compressed replacement cluster PSN for each list entry is determined according to a PSN of a first sector of a spare area of the data storage media and a difference between the replacement cluster PSN of each list entry and the PSN of the first sector of the spare area.

53. The method as claimed in claim 51, wherein the compressed replacement cluster PSN for each list entry is determined according to a look-up table.

54. The method as claimed in claim 40, further comprising:
decompressing the at least one compressed group stored; and
providing at least one decompressed group of the defect list for the disc drive system to monitor the defects of the data storage media.

55. The method as claimed in claim 54, wherein decompressing comprises decompressing a part of the at least one compressed group and providing the decompressed part of the at least one of the groups for the disc drive system.

56. A disc drive system for accessing a data storage media, comprising:
a front-end unit performing an operation on the data storage media and retrieving a defect list from the data storage media, comprising a plurality of list entries;
a memory interface;
a memory unit storing the defect list from the front-end unit via the memory interface; and
a control unit comprising:
a defect information processing element obtaining the defect list from the memory unit via the memory interface and dividing the list entries of the defect list into a plurality of groups;
a compression element compressing the groups of the defect list from the defect information processing element; and
a determination element determining at least one of the compressed groups from the compression element to store in the memory unit for the front-end unit via the memory interface.

57. The disc drive system as claimed in claim 56, wherein the determination element determines the at least one of the compressed groups for storing according to a current location of the data storage media on which the front-end unit performs an operation.

58. The disc drive system as claimed in claim 57, wherein the defect information processing element divides the list entries of the defect list into the groups according to a defect cluster physical sector number (PSN) of each list entry.

59. The disc drive system as claimed in claim 56, wherein the determination element determines the at least one of the compressed groups for storing according to an operation performed by the front-end unit on the data storage media.

60. The disc drive system as claimed in claim 59, wherein the defect information processing element divides the list entries of the defect list into the groups according to a defective entry type of each list entry.

61. The disc drive system as claimed in claim 56, wherein the determination element determines the at least one of the compressed groups for storing according to a current location of the data storage media on which the front-end unit performs the operation and the operation performed.

62. The disc drive system as claimed in claim 61, wherein the defect information processing element divides the list entries of the defect list into the groups according to a defect cluster physical sector number (PSN) and a defective entry type of each list entry.

63. The disc drive system as claimed in claim 56, wherein the compression element compresses the groups of the defect list by dividing the list entries of the defect list into a plurality of zones according to a defect cluster physical sector number (PSN) of each list entry and replacing the defect cluster physical sector number (PSN) of list entries in each zone with a compressed defect cluster PSN therefor.

64. The method as claimed in claim 63, wherein the compression element divides the list entries of the defect list into a plurality of zones by dividing the sectors of the data storage media into zones according to the physical sector numbers thereof and distributing the list entries of the defect list to each zone accordingly.

65. The method as claimed in claim 64, wherein the compression element determines the compressed defect cluster PSN for each list entry in each zone according to a physical sector number of a first sector in a corresponding zone, and a difference between the defect cluster PSN of each list entry and the PSN of the first sector of the corresponding zone.

66. The disc drive system as claimed in claim 63, wherein the compression element determines the compressed defect cluster PSN for each list entry of each zone according to a look-up table.

67. The disc drive system as claimed in claim 63, wherein the compression element further compresses the defect list by replacing a replacement cluster PSN of each list entry with a compressed replacement cluster PSN therefor.

68. The disc drive system as claimed in claim 67, wherein the compression element determines the compressed replacement cluster PSN for each list entry according to a PSN of a first sector of a spare area of the data storage media and a difference between the replacement cluster PSN of each list entry and the PSN of the first sector of the spare area.

69. The disc drive system as claimed in claim 67, wherein the compression element determines the compressed replacement cluster PSN for each list entry according to a look-up table.

70. The disc drive system as claimed in claim 56, wherein the control unit further comprises a decompression element obtaining the compressed defect list from the memory unit via the memory interface to decompress the obtained defect list.

71. The disc drive system as claimed in claim 70, wherein the control unit further comprises a monitor element receiving the decompressed defect list from the decompression element and monitoring the defects of the data storage media therewith.
